(19) United States
(12) Patent Application Publication
(10) Pub. No.: US 2013/0325189 A1
(43) Pub. Date: Dec. 5, 2013

(54) NEED IDENTIFYING DEVICE, AIR-CONDITIONING CONTROLLING SYSTEM, NEED IDENTIFYING METHOD, AND AIR-CONDITIONING CONTROLLING METHOD

(71) Applicant: Azbil Corporation, Tokyo (JP)

(72) Inventor: Mayumi MIURA, Tokyo (JP)

(21) Appl. No.: 13/909,446

(22) Filed: Jun. 4, 2013

(30) Foreign Application Priority Data
Jun. 4, 2012 (JP) 2012-126823

(51) Int. Cl. G05D 23/19

(52) U.S. Cl. CPC G05D 23/19
USPC 700/276

(57) ABSTRACT

A need identifying device includes an inputting unit and a need identifying unit. The inputting unit receives, from an informant, a need pertaining to air-conditioning. The need identifying unit identifies whether the need from the informant is a temporary need or a persistent need, based on information pertaining to an activity that stabilizes the metabolic rate of the informant.

### CROSS REFERENCE TO RELATED APPLICATION

This application claims priority to Japanese Patent Application No. 2012-126823, filed on Jun. 4, 2012, the entire content of which being hereby incorporated herein by reference.

### FIELD OF TECHNOLOGY

The present invention relates to a need identifying device and need identifying method for identifying whether a need regarding air-conditioning from an informant is a temporary need or a persistent need, and relates to an air-conditioning controlling system and air-conditioning controlling method for applying the identification result to the air-conditioning control.

### BACKGROUND

In buildings wherein air-conditioning controlling systems are deployed, usually reporting of needs by occupants regarding air-conditioning (for example, “Hot,” “Cold,” “Increase the room temperature by XX° C.,” “Decrease the room temperature by XX° C.,” and the like) is typically a troublesome task regardless of the reason why the occupant is present (for example, for office work by the occupant in the case of an office). Moreover, for needs (hereinafter termed “weak needs”) in a situation wherein the occupant is not strongly aware of his or her thermal discomfort (a situation wherein the occupant is comfortable or somewhat warm or somewhat cold), the occupant will not be strongly aware of that feeling, and thus no need report is performed. As a result, the need reports tend to be primarily for those needs (hereinafter termed “strong needs”) that are relatively strong when compared to the “weak needs.”

As a result, if, for example, the temperature setting value were to be decreased excessively as the result of the air-conditioning control responding to a strong need of an occupant in terms of “Hot,” then even if the room environment was improved to a suitable state that was neither hot nor cold during the process, there would be a tendency for there to be no report of a “weak need” of “Neither hot nor cold.” Because this “weak need” tends to not be reported by an occupant, the result of maintaining a room temperature setting value that was decreased temporarily will be that, eventually, the opposing “strong need” will be evoked. For example, even if the room temperature setting value is reduced too far as the result of a response to a need report of “Hot,” because there is no need report of “Somewhat hot” or “Somewhat cold,” the room temperature setting value will be maintained as-is. The result is that the temperature of the room will be reduced until the opposing “Cold” “strong need” is reported.

Moreover, when a “Cold” need is reported, there is the possibility that the room temperature setting value will be increased too much, resulting in the room temperature being raised to the extent that the opposing “Hot” “strong need” will be reported. The repetitive iteration of these opposing “strong needs”, in the worst-case scenario, will cause the occupant to cyclically feel the opposing sensations of “Hot” and “Cold.” This type of iteration is not only uncomfortable for the occupant and troublesome, but also may result in wasted energy through destabilization of control.

Given this, there has been a proposal for a reporting-type air-conditioning system wherein the occupants themselves directly report their needs regarding air-conditioning and the number of reports are tabulated periodically, provided with an individual report cancelling portion for canceling a report when a specific effective time has elapsed since the report was inputted, a remaining time displaying portion for displaying how much of the effective time is remaining, enabling the informant to check how much of the effective time is remaining, and a notifying portion for prompting the informant to report again. (See, for example, Japanese Patent 4604630.)

As described above, in a reporting-type air-conditioning controlling system, the difficulty in performing reporting of “weak needs” tends to cause be control to become destabilized. Even in the reporting-type air-conditioning controlling system disclosed in Patent Document 1, there is no change to the fact that there is a tendency for “weak needs” to not be reported, resulting in a tendency to add up the “strong needs,” and thus there is a problem in that control tends to become destabilized.

Moreover, the effective time setting is effective in a case wherein the hot or cold feeling of the informant improves uniformly in the direction of comfort with the passage of time. However, in practice, often, such as in cases wherein the magnitude of the decrease in the temperature setting value in response to a need report of “Hot” is inadequate, the need continues to exist, rather than being resolved. When the effective time setting is used in such a case, the informant, for whom the need has not been resolved, will have to report the same need again each time a report is canceled. In the worst case, the occupant will be forced to choose between either going through the trouble of performing the reporting task at regular intervals, or to endure an unsatisfactory environment, which tends to increase the dissatisfaction of the occupant with the air-conditioning controlling system. Consequently, the effective time setting does not ameliorate the destabilization of control due to the tendency to not report the “weak needs.”

### SUMMARY

The present invention was created in order to solve the problem set forth above, and thus an aspect thereof is to provide a need identifying device, an air-conditioning controlling system, a need identifying method, and an air-conditioning controlling method, able to reduce the likelihood of destabilization of control while reducing the burden of need reporting (frequency and work) on behalf of the informants.

A need identifying device according to the present invention includes an inputting unit that receives a need pertaining to air-conditioning from an informant, and a need identifying unit that identifies whether a need from an informant is a temporary need or a persistent need, based on information pertaining to an activity that stabilizes the metabolic rate of the informant.

Additionally, one example of a configuration of the need identifying device according to the present invention further includes an occupancy status controlling unit that controls occupancy information of the informant as information pertaining to an activity that stabilizes the metabolic rate of the informant, wherein the need identifying unit includes an identification rule storing unit that stores an identification rule in advance, and an identification processing unit that identifies whether the need from the informant is a temporary need or a persistent need, based on occupancy information of the informant and on the identification rule.

Additionally, in one example of a configuration of the need identifying device according to the present invention, the occupancy status controlling unit calculates an occupancy continuity time of the informant in a specific space, as occupancy information of the informant, the identification rule storing unit stores a rule, as the identification rule, for identifying a persistence category of a need by comparing the occupancy information of the informant to a predetermined identification threshold value, and the identification processing unit identifies the need from the informant as a temporary need or a persistent need by comparing the occupancy continuity time to the identification threshold value following the identification rule.

Additionally, in one example of a configuration of the need identifying device according to the present invention, the occupancy status controlling unit calculates, as the occupancy information of the informant, an occupancy equivalent time, wherein the occupancy continuity time of the informant in a specific space is corrected by a non-occupancy continuity time, the identification rule storing unit stores a rule, as the identification rule, for identifying a persistence category of a need by comparing the occupancy information of the informant to a predetermined identification threshold value, and the identification processing unit identifies the need from the informant as a temporary need or a persistent need by comparing the occupancy equivalent time to the identification threshold value following the identification rule.

An air-conditioning controlling system according to the present invention includes the need identifying device, a control plan storing unit that stores, in advance, respectively for temporary needs and for persistent needs, control plans wherein rules for changing control setting values for air-conditioning in accordance with a need from an informant are established, a control plan determining unit that determines, from the control plans stored in the control plan storing unit, a control plan corresponding to the identification result of the need identifying device, as a control plan to be applied to the air-conditioning equipment, and an equipment controlling unit that controls the air-conditioning equipment based on the control plan determined by the control plan determining unit.

Furthermore, in one example structure of the air-conditioning controlling system according to the present invention, a control plan corresponding to a temporary need is a control plan that establishes that the control setting value will change in accordance with a need from an informant, and that the control setting value will be returned to the value from prior to the change after a specific sustaining time has elapsed, and a control plan corresponding to a persistent need is a control plan that establishes that the control setting value will be changed on a persistent basis in accordance with a need from the informant.

A need identifying method according to the present invention includes an inputting step for receiving, from an informant, a need pertaining to air-conditioning, and a need identifying step for identifying whether the need from the informant is a temporary need or a persistent need, based on information pertaining to an activity that stabilizes the metabolic rate of the informant.

An air-conditioning controlling method according to the present invention includes each of the aforementioned steps, a control plan determining step for determining a control plan, from the control plans stored in a control plan storing unit, a control plan corresponding to the identification result of the need identifying step, as a control plan to be applied to the air-conditioning equipment by referencing the control plan storing unit that stores, in advance, respectively for temporary needs and for persistent needs, control plans wherein rules for changing control setting values for air-conditioning in accordance with a need from an informant are established, and an equipment controlling step for controlling the air-conditioning equipment based on the control plan determined by the control plan determining step.

The present invention enables the identification of a need from an informant as being of the persistent type, focusing on the time of persistence, through the provision of a need identifying unit that identifies whether a need from an informant is a temporary need or a persistent need, based on information pertaining to activities that stabilize the metabolic rate of the informant. Consequently, the application of the identification result to air-conditioning control enables a reduction in the likelihood of destabilization of the air-conditioning control while reducing the burden on the informant.

Moreover, in the present invention, occupancy equivalent time wherein the occupancy continuity time is corrected by the non-occupancy continuity time of the informant in the specific space is calculated as occupancy information for the informant, and this occupancy equivalent time is compared to an identification threshold value to identify whether the need from the informant is a temporary need or a persistent need, enabling an improvement in the accuracy of the need category identification, taking into account the metabolic rate of the informant.

Moreover, the present invention, through determining, as the control plan that is to be applied to the air-conditioning equipment, from among control plans that are stored in a control plan storing unit, a control plan corresponding to the identification result by the need identifying device, and by then controlling the air-conditioning equipment based on the control plan that has been determined, is able to apply the identification result by the need identifying device to the air-conditioning control.

### BRIEF DESCRIPTION OF THE DRAWINGS

FIG. 1 is a diagram illustrating an example of an occupant reporting-type air-conditioning controlling system.

FIG. 2 is a diagram illustrating the relationship between the metabolic rate of an occupant and PMV.

FIG. 3 is a block diagram illustrating a structure of a need identification-type air-conditioning controlling device according to Example according to the present invention.

FIG. 4 is a block diagram illustrating the structure of a need identifying portion according to the Example according to the present invention.

FIG. 5 is a flowchart for explaining the operation of the need identification-type air-conditioning controlling device according to the Example according to the present invention.

FIG. 6 is a diagram illustrating the relationship between the occupancy status of an occupant and occupancy continuity time.

FIG. 7 is a diagram for explaining a control plan according to the Example according to the present invention.

FIG. 8 is a diagram illustrating an alternate example a control setting value controlling device in response to a reported need, according to the Example according to the present invention.

FIG. 9 is a flowchart for explaining the operation of the occupancy status controlling portion according to the Example according to the present invention.

FIG. 10 is a diagram illustrating an example of occupancy history information controlled by the occupancy status controlling portion according to the Example according to the present invention.

FIG. 11 is a diagram illustrating the relationship between the occupancy status of an occupant and occupancy equivalent time.

FIG. 12 is a block diagram illustrating a structure of a need identification-type air-conditioning controlling device according to Another Example according to the present invention.

FIG. 13 is a flowchart for explaining the operation of the occupancy status controlling portion according to the Another Example according to the present invention.

FIG. 14 is a flowchart for explaining the method of calculating the occupancy equivalent time in the Another Example according to the present invention.

FIG. 15 is a diagram illustrating an example of calculation of an occupancy equivalent time in the Another Example according to the present invention.

FIG. 16 is a diagram illustrating an example of occupancy history information controlled by the occupancy status controlling portion according to the Another Example according to the present invention.

FIG. 17 is a diagram illustrating an example of occupancy history information controlled by the occupancy status controlling portion according to Yet Another Example according to the present invention.

FIG. 18 is a flowchart for explaining the operation of the occupancy status controlling portion according to the Yet Another Example according to the present invention.

FIG. 19 is a flowchart for explaining the method of calculating the occupancy equivalent time in the Yet Another Example according to the present invention.

### DETAILED DESCRIPTION

The present invention applies to a method and device for controlling air-conditioning of a type that adapts to needs, for applying needs of occupants regarding air-conditioning, and is not limited to cases wherein a reporting-type air-conditioning controlling system, wherein occupants input needs directly into the air-conditioning controlling system, is used. That is, the present invention applies to both (A) the case wherein a need is received from an occupant and the facilities manager uses a Building and Energy Management System (BEMS), or the like, to apply the occupant need in the air-conditioning control and also (B) the case wherein the occupants themselves report their needs regarding air-conditioning directly to the air-conditioning controlling system (including also cases wherein the occupant needs are received remotely by an Application Service Provider (ASP) service, or the like, to be applied in the control).

Moreover, the present invention applies to a building for which presence/absence control of an occupant is possible for a space that is occupied primarily by that occupant (hereinafter termed an “occupied space”). Here the occupied space is an area within the building occupied primarily by that occupant, and indicates a unit of space for which presence/absence control is possible. Insofar as it is an area within a building that is a unit wherein presence/absence control is possible, such as, for example, a building, a floor, a partitioned room, or a more finely defined air-conditioning zone (a unit for air-conditioning control within the building), or an area of a group of desks that includes a plurality of desks, an area around a desk that is used primarily by the occupant, or the like, the size of the area does not matter. The presence/absence control of the occupied area of the occupant is achieved through, for example, an entry/exit controlling system or location identifying system, or the like, that involves the identification of individuals.

In the explanation of the present invention, the following distinctions are drawn between “occupants,” “informants,” and “need inputters.” In the present invention, an individual who causes any given air-conditioning zone that is subject to control by the air-conditioning control system within the building to be an “occupied space” is called an called “occupant.” Whether or not a reporting action occurs depends on the occupants. Moreover, in the present invention occupants who initiate an activity to report the need for a change in air-conditioning (including those who do so via voice notification using a telephone, or the like), are known as “informants.” Regardless of whether or not an occupant feels dissatisfaction regarding the air-conditioning environment, if no reporting activity is initiated, he or she will not be treated as an “informant.” Moreover, in the present invention, an individual who inputs, into the air-conditioning controlling system, a need by an occupant for a change in the air-conditioning, for the purposes of applying it in the air-conditioning control, are “need inputters.” When a reporting-type air-conditioning controlling system wherein the occupants input needs for changes directly into the air-conditioning controlling system, then the informants and the need inputters are identical. Moreover, in other air-conditioning controlling systems, there are systems wherein the informants report needs for changes (providing notification through telephone, email, or the like), to facilities managers who are the need inputters, and the facilities managers input those needs into the air-conditioning controlling system.

The inventor has focused on the fact that, in air-conditioning controlling systems such as set forth above, control that is different from that for normal need reports is appropriate for temporary (in contradistinction to “persistent”) need reports.

A need that that is reported for an air conditioner, as typically occurs within an office, often is due to an increased metabolic rate due to physical activity (after arriving at work, after returning from work, after moving to a conference room, or the like) or due to eating (lunch, or the like). However, because such needs tend to be on the side that resolve themselves with the passage of time, even if there is no change in the room environment, they tend to evoke a destabilized state more that would needs that arise due to an unsuitable ambient environment. For example, according to Takuya TAIRA, et al., “A Comparison of Changes in Postprandial Energy Expenditure at Breakfast, Lunch, and Supper Using a Human calorimeter” (Journal of Nutrition, Vol. 68, No. 6, Pgs. 373-377, 2010), the meal-induced generation of heat falls to a stable state after between about 30 and 40 minutes. Consequently, the application of adaptive control reflecting these characteristics regarding temporary needs can reduce the likelihood of destabilization of control.

Furthermore, the present inventor has focused on the use of occupancy information in the occupied space by the occupant when identifying a temporary need. The relationship between needs and informant actions can be inferred from the timing of the need report and the occupancy information at that time, making it possible to increase the accuracy of identification of a temporary need without measuring the metabolic rate and without prompting the informant to input information for use in identification.

### Example

Forms for carrying out the present invention will be explained below in reference to the figures. In the present example, identification of whether or not a need is a temporary need is made, from occupancy continuity time calculated using the report issuing time and occupancy information of the informant, and the air-conditioning control plan is determined based on the identification result. Here the “control plan” refers to the establishment of rules for changing the control setting values for the air-conditioning in response to needs.

In the present invention, information establishing a correlation between an occupant, an occupied space occupied by the occupant, an air-conditioning zone corresponding to that occupied space (an air-conditioning zone matching that occupied space, an air-conditioning zone that includes that occupied space, or an air-conditioning zone that is included within that occupied space), and the air-conditioning device that is to be controlled is maintained in the need identification-type air-conditioning controlling device that is described below. This information may be stored in advance in the need identification-type air-conditioning controlling device, or may be inputted by a facilities manager, or the like, at the time of starting the operation of the need identification-type air-conditioning controlling device, or this information may be sent with a need that is sent by a need inputter and received by the need identification-type air-conditioning controlling device. The need of the informant regarding air-conditioning is reflected into the control (through, for example, changing a setting value) of the air-conditioning equipment of the air-conditioning zone corresponding to the informant, based on this information that is stored in the need identification-type air-conditioning controlling device.

Note that when the informant inputs the change need through a separate need inputter, then information that identifies the informant is also sent together with the need. As a result, the need of the informant is reflected into the control of the air-conditioning equipment corresponding to that informant. Even if there is a plurality of air-conditioning zones within a single occupied space, insofar as it is possible to identify the informant, it will be possible to identify the air-conditioning equipment corresponding to that informant, enabling the need of that informant to be reflected into control of that air-conditioning equipment. Moreover, even if there is a plurality of occupants in a single air-conditioning zone, still there is no problem insofar as the air-conditioning equipment corresponding to that informant is identified.

In the present invention, the critical point is that of identification of changing needs of informants relative to air-conditioning focusing on persistence time (hereinafter termed “persistence classification”), to be applied to air-conditioning control. In the present invention, appropriate design changes are possible through the ordinary engineering knowledge of one skilled in the art, regardless of the air-conditioning method (for example, discrete versus central, and so forth), the type of air-conditioning equipment used, the element controlled by air conditioning (temperature, humidity, dissipation, or compound control thereof, or the like), and regardless of the type of terminals for inputting needs (BEMS, PCs, mobile telephones, smart phones, dedicated input terminals, and so forth), and the like.

In the present example, an explanation will be given for an example of an occupant reporting-type air-conditioning controlling system wherein the occupants themselves input their own needs into the air-conditioning controlling system. An example wherein an entry/exit controlling system for controlling the entry/exit of occupants into/out of the occupied space will be explained as an occupant presence/absence controlling system. This entry/exit controlling system has information for identifying a detected occupant.

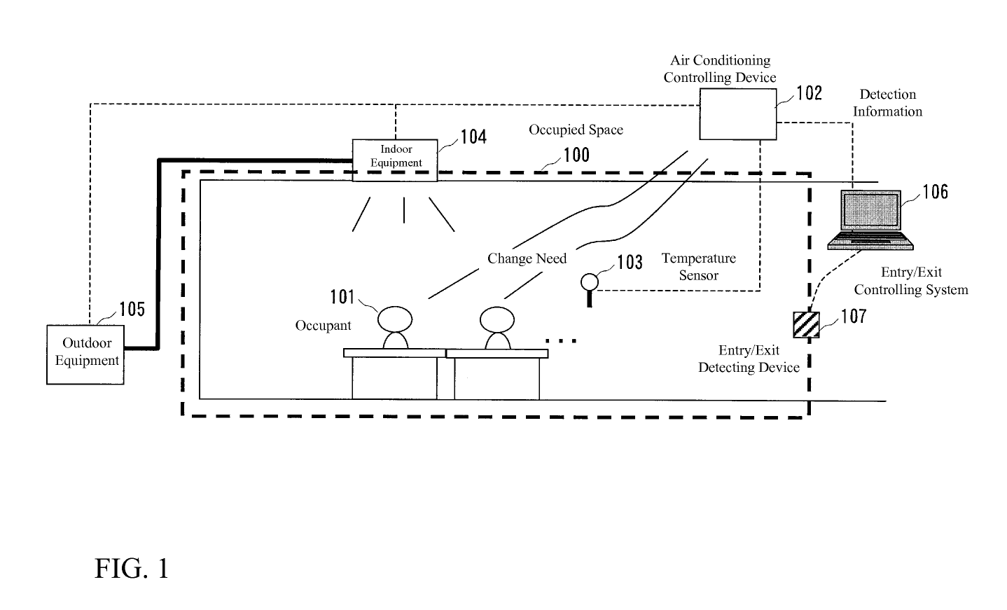

FIG. 1 illustrates an example of an occupant reporting-type air-conditioning controlling system. In FIG. 1, 100 is an occupied space, 101 is an occupant, 102 is an air-conditioning controlling device (a controller) for receiving a change need, 103 is a temperature sensor for measuring the temperature of the occupied space 100, 104 is indoor equipment, 105 is outdoor equipment, 106 is an entry/exit controlling system, and 107 is an entry/exit detecting device (such as a card reader that reads an ID card of the occupant 101), used in the entry/exit controlling system 106. The air-conditioning controlling device 102 controls the air-conditioning equipment (the indoor equipment 104 and the outdoor equipment 105) to cause the room temperature, measured by the temperature sensor 103, to match a room temperature setting value. FIG. 1 is an example of a single air-conditioning zone matching the occupied space 100, but even if, for example, the occupied space 100 is one floor of a building and a plurality of air-conditioning zones for air-conditioning equipment is included therein, still this is applicable insofar as the air-conditioning equipment to be controlled, corresponding to the need of the informant, can be identified. Moreover, while an example of cooling in the summertime will be explained in the present example, obviously the present invention can be applied also to heating in intermediate seasons and in the winter.

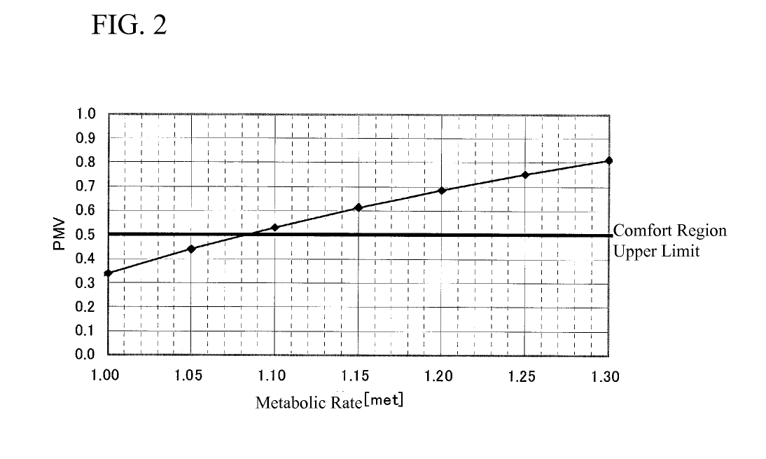

FIG. 2 shows the relationship between the metabolic rate of the occupant and the Predicted Mean Vote (PMV), which is an indicator of the perception of being hot or cold, expressing the comfort of the air-conditioned area. In the example in FIG. 2, factors other than the metabolic rate of the occupant that affect the PMV (temperature, humidity, dissipation, air flow, and amount of clothing) are assumed to be constant values, envisioning an office in the summertime. Specifically, the dissipation temperature is defined as 27° C., the air flow is defined as 0.1 m/s, the relative humidity is defined as 50%, and the amount of clothing is defined as 0.5 (clo).

As an energy/electricity saving strategy, there is a tendency for room temperature setting values for air-conditioning to be set in a direction that produces an adverse effect on the indoor environment, based on the values recommended by the Ministry of the Environment (28° C. in the summertime and 20° C. in the wintertime). However, because room temperature is not the only factor that affects comfort, adverse changes in the other factors will cause a deviation from the ±0.5 range that is the PMV comfort zone. In the example in FIG. 2, a case is illustrated wherein the temperature is set 1° C. toward the comfortable side (27° C.) from the value recommended by the Ministry of the Environment, but when, for example, the metabolic rate of the occupant is increased by 10% for 21.1 (met) from the standard metabolic rate of 1.0 (met) through eating, the PMV can be seen to exceed the 0.5 that is the upper limit for the comfort zone, which can be understood to potentially become a cause giving rise to a need report after eating.

However, because a need that is produced through eating (such as lunch) or through physical activity (after arriving at work, after returning from work, after moving to a conference room, or the like) is due to a temporary increase in the metabolic rate, if the metabolic rate falls and stabilizes with the passage of time, then there will eventually be movement in the direction of resolution, even if there is no change in the room environment. Specifically, even if one feels too hot immediately after returning to the office after being out, as time elapses directly after returning to the office, this perception of being hot may resolve itself notwithstanding there being no change in the room environment, such as in the temperature, humidity, or the like. On the other hand, an occupant who is continuously working in the office will have a metabolic rate that is in a steady-state, so the factor that triggers a need will usually be the room environment, rather than a change in the environment within the body on the occupant side. In such a case, there is a high likelihood that the need will persist unless there is an appropriate change to the room environment in response to the need reported by the occupant.

In this way, in addition to change need classifications (hereinafter termed “change classifications”) wherein the direction of the change in the air-conditioning (warmer vs. cooler) and the intensity of the need are related in the need report, such as in “Hot,” “Somewhat hot,” “Neither hot nor cold,” “Somewhat cold,” “Cold,” “Increase by XX° C.,” “Decrease by XX° C.,” and the like, there are also categories that focus on the persistence (hereinafter termed “persistence categories”), such as needs that will eventually move in the direction of resolution even in the absence of change in the room environment (hereinafter termed “temporary needs”) vs. needs with a high likelihood of persisting if there is no change in the room environment (hereinafter termed “persistent needs”).

In particular, needs that result from, for example, an increase in metabolic rate due to eating, climbing the stairs, moving outside the office or the like, tend to be temporary, strong needs, and sometimes result in multiple repeated reports of strong needs in a short period of time. However, because the perception itself of the need will move in the direction of resolution with the passage of time, if one were to focus only on the change category, to apply the same type of control as for persistent needs, then there will be a tendency for the temporary needs to trigger destabilization of control, as described above. Because of this, a temporary need is identified and a control plan that differs from that used for a persistent need is applied in order to reduce the likelihood of destabilization of control.

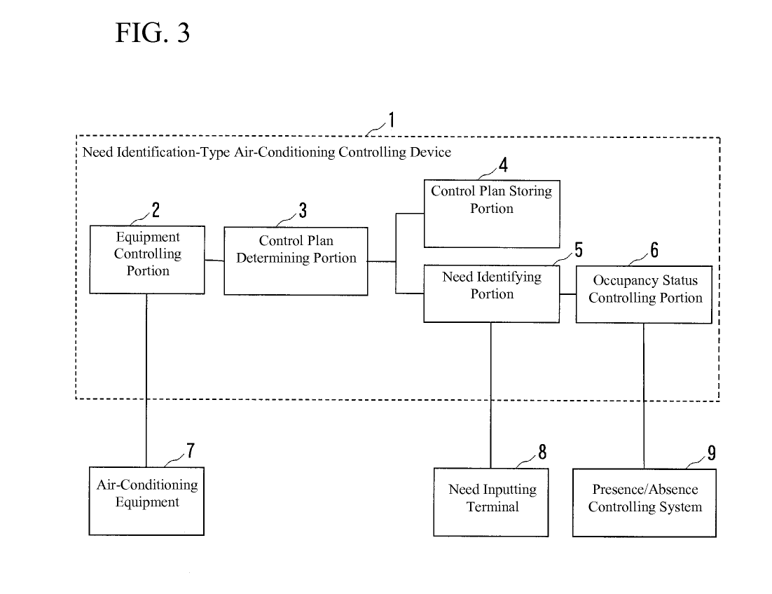

FIG. 3 is a block diagram illustrating the structure of a need identification-type air-conditioning controlling device according to the present example. The need identification-type air-conditioning controlling device 1 is provided with an equipment controlling portion 2, a control plan determining portion 3, a control plan storing portion 4, a need identifying portion 5, and an occupancy status controlling portion 6.

The equipment controlling portion 2 controls air-conditioning equipment 7 based on the control plan established by the control plan determining portion 3.

The control plan determining portion 3 determines, from among the control plans that are stored in the control plan storing portion 4, the control plan to be applied to the air-conditioning equipment 7 based on the control plan that is in effect at the point in time of processing a need and based on the identification result by the need identifying portion 5.

Control plans that are to be applied in response to the identification results by the need identifying portion 5 are set up in advance and stored in the control plan storing portion 4. These control plans are set up in advance by a control contractor or the facilities manager.

Temporary need identification rules that use the occupancy information produced by the occupancy status controlling portion 6 are set up in advance and stored in the need identifying portion 5. The temporary need identification rules are set up in advance by the control contractor, the facilities manager, or the energy manager. The need identifying portion 5 identifies the persistence category of a reported need based on the identification rules, and the persistence category is stored together with the need category (hot, cold, etc.).

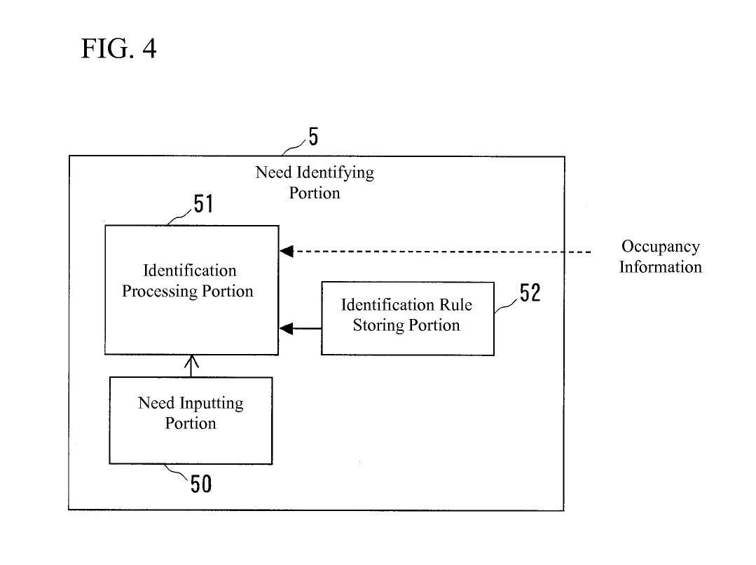

FIG. 4 is a block diagram illustrating the structure of the need identifying portion 5. The need identifying portion 5 is structured from a need inputting portion 50 for receiving a change need that is inputted from a need inputting terminal 8, an identification processing portion 51 for identifying the persistence category of the need, and an identification rule storing portion 52 for storing the identification rule.

The occupancy status controlling portion 6 uses information of a presence/absence controlling system 9 to control the occupancy information that indicates the occupancy status for each individual occupant. The need inputting terminal 8 may be a PC, a mobile telephone, a smart phone, a dedicated remote control terminal, or the like.

The presence/absence controlling system 9 is a system for controlling the presence/absence status for individual occupants, or a system for detecting changes in the presence/absence statuses. The presence/absence controlling system 9 may be a system for detecting the presence/absence of an occupant using a general-use presence/absence sensor or a video camera, or the like, or may be a system able to detect the presence/absence of an occupant indirectly through detecting locations of occupant individuals or through entry/exit control (such as a presence/absence detecting system with occupant recognition, an entry/exit controlling system, a system for location detection by detecting the locations of occupants through the use of RFID (Radio Frequency Identification), or the like).

Note that although the need identification-type air-conditioning controlling device 1 is provided within the air-conditioning controlling device 102 illustrated in FIG. 1, the need identifying portion 5 may be provided outside of the air-conditioning controlling device 102.

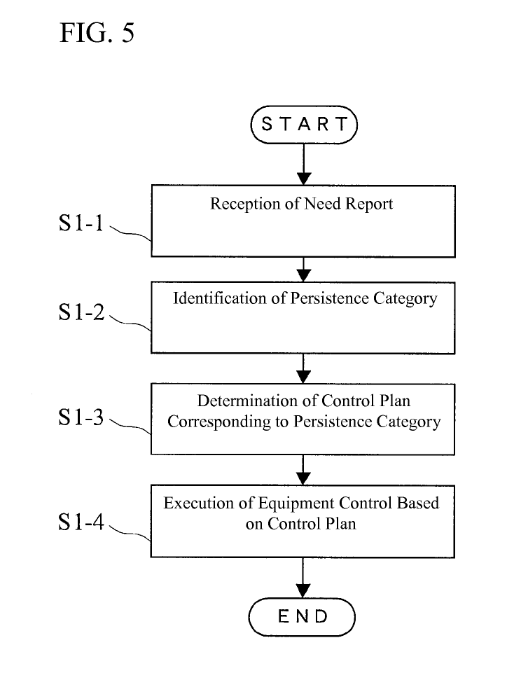

The operation of the air-conditioning controlling system of the present example will be explained next. FIG. 5 is a flowchart for explaining the operation of the need identification-type air-conditioning controlling device 1 when an occupant need report has been received from a need inputting terminal 8. The need inputting terminal 8 sends, to the need identifying portion 5, the UID that is the information that identifies the occupant (informant) who reported the change request for the air conditioning by operating the need inputting terminal 8, the change category DS of the need inputted by this informant and the report timing Stime thereof, and the need inputting portion 50 of the need identifying portion 5 stores, as a need V(UID, DS, Stime), the information that has been received (Step S1-1 in FIG. 5).

While, in the present example, the explanation is for a case wherein the identifying information UID is the same for the need identification-type air-conditioning controlling device 1 and for the presence/absence controlling system 9, instead the identifying information used in the presence/absence controlling system 9 may be different from the identifying information UID used in the need identification-type air-conditioning controlling device 1. In this case, a conversion table or converting function F, for converting between the occupant identifying information SID used by the presence/absence controlling system 9 and the occupant identifying information UID used by the need identification-type air-conditioning controlling device 1 may be provided in the occupancy status controlling portion 6.

Moreover, for simplicity, in the present example it is assumed that there are only two possible change categories DS that can be selected by the user, “Hot” and “Cold,” where “Hot” is indicated by the value “1,” and “Cold” is indicated by the value “−1.” That is, a need reported by the UID=500 occupant as “Hot” with a report time of 10:10 a.m. would be stored as V(500, 1, 10:10), and a need reported as “Cold” at that same time would be stored as V(500, −1, 10:10).

Note that while in this example the informant identifying information (UID), the change category DS, and the report time Stime are sent from the need inputting terminal 8, the report time Stime need not necessarily be sent from the need inputting terminal 8, but instead the report time Stime may be added by the need inputting portion 50 using, for the report time, the time at which the need report is received.

When a need V(UID, DS, Stime) is received from a need inputting terminal 8, the identification processing portion 51 of the need identifying portion 5 queries the occupancy status controlling portion 6 regarding the occupancy continuity time Hcs(UID, Stime), which is occupancy information for the informant that is identified by the informant identifying information UID, to identify the persistence category of the need V(UID, DS, Stime) based on the occupancy continuity time Hcs(UID, Stime) obtained from the occupancy status controlling portion 6 and on a temporary need identification rule that is set in advance in the identification rule storing portion 52 (Step S1-2 in FIG. 5).

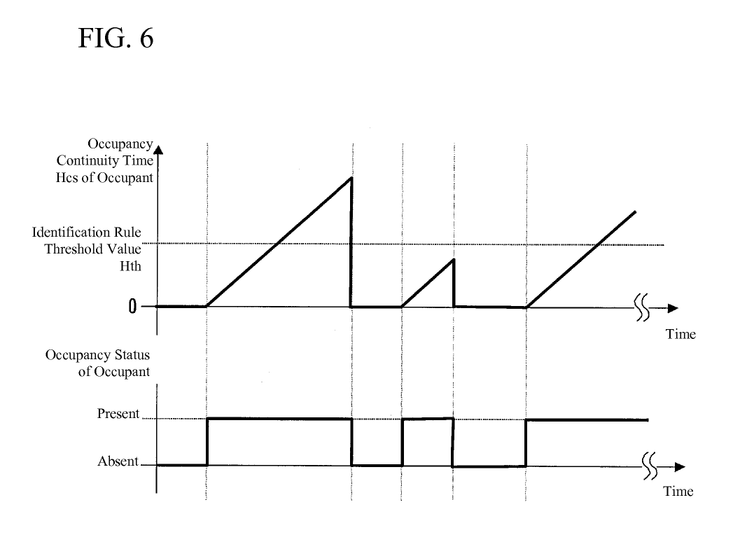

Here the occupancy continuity time is the cumulative value for the time over which the occupant has been continuously present in the occupied space (expressed appropriately, such as in hours, minutes, and seconds), and is 0 if the occupant is not present in the occupied space. FIG. 6 is a diagram illustrating the relationship between the occupancy status of an occupant and occupancy continuity time Hcs. The occupancy continuity time is calculated by the occupancy status controlling portion 6 using detection information from the presence/absence controlling system 9, and the operation of the occupancy status controlling portion 6 will be described below.

Temporary need identification rules that use the occupancy continuity time Hcs(UID, Stime) are set up in advance in the identification rule storing portion 52 of the need identifying portion 5 by a control provider or facilities manager, or the like. In the present example, the explanation will be for an example wherein the persistence category of a need is determined based on a comparison with a need category identification threshold value (hereinafter termed a “threshold value”) Hth, as the temporary need identification rule.

The identification processing portion 51 of the need identifying portion 5 compares the occupancy continuity time Hcs(UID, Stime) at the point in time of the report time Stime by the informant, identified in the informant identifying information UID, to the threshold value Hth that has been set in advance, to determine a persistence category identification flag Ftmp (hereinafter termed the “identification flag”) that indicates the persistence category of the need V(UID, DS, Stime). Specifically, the identification processing portion 51 sets the identification flag Ftmp to Ftmp=1 when Hcs(UID, Stime)<Hth, that is, when the occupancy continuity time Hcs(UID, Stime) is less than the threshold value Hth, and sets the identification flag Ftmp to Ftmp=0 if Hcs(UID, Stime)≧Hth, that is, if the occupancy continuity time Hcs(UID, Stime) is equal to or greater than the threshold value Hth.

An identification flag Ftmp=1 indicates that the need V(UID, DS, Stime) is a temporary need, and the identification flag Ftmp=0 indicates that the need V(UID, DS, Stime) is a persistent need.

The threshold value Hth may be set in advance using, as a guideline, the time until stabilization of the metabolic rate of an occupant (for example, 30 minutes) after a normal activity in an office, such as eating or movement. Given this, if, for example, the threshold value Hth is 30 minutes, then if the occupancy continuity time of the informant at the point in time of the report time Stime is less than 30 minutes, then the need V(UID, DS, Stime) will be a temporary need (Ftmp=1), and if the occupancy continuity time is greater than 30 minutes, then the need V(UID, DS, Stime) will be a persistent need (Ftmp=0).

The identification processing portion 51 associates a need change category DS and an identification flag Ftmp with the need V(UID, DS, Stime) that has been received from the need inputting terminal 8, and stores these as a need status DC(DS, Ftmp).

Following this, the control plan determining portion 3 determines a control plan corresponding to the need V(UID, DS, Stime) being processed (Step S1-3 in FIG. 5). The control plan determining portion 3 uses the control plan that is currently applied to the air-conditioning equipment 7 corresponding to the informant identified by the informant identifying information UID at that point in time (hereinafter termed the “existing control plan”), the control plans set in advance in the control plan storing portion 4, and the need status DC(DS, Ftmp) that is held in the need identifying portion 5, to determine the new control plan to be applied to the air-conditioning equipment 7.

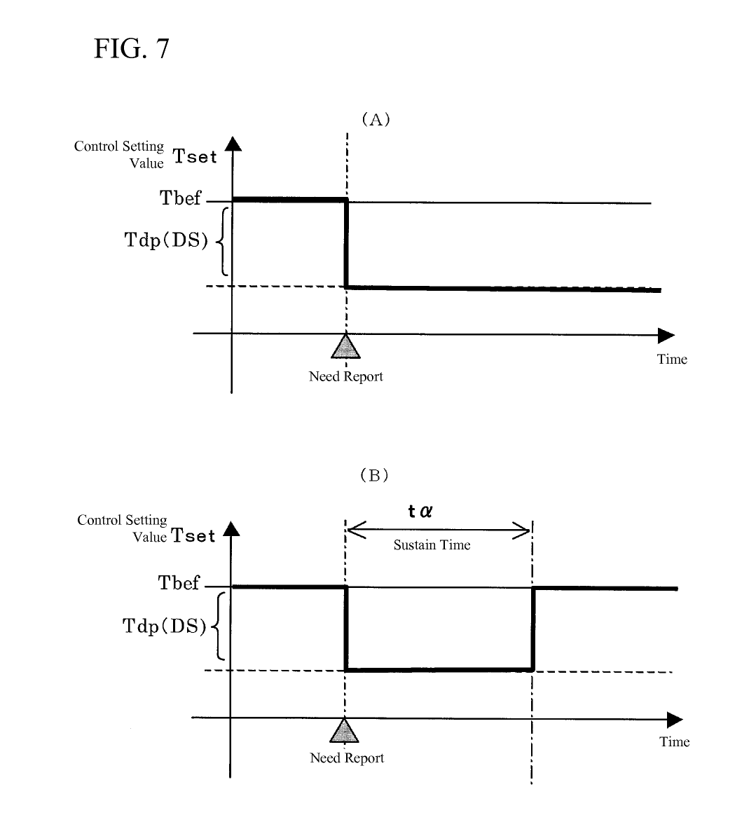

Control plans corresponding to temporary needs and to persistent needs are each set up in advance in the control plan storing portion 4. Conventional general-use control plans (conventional control plans that are executed in accordance with the change category, without identifying the persistence category) may be established as the control plans corresponding to persistent needs (control plans corresponding to Ftmp=0). For simplicity in the explanation, in the present example a control plan wherein the control setting value Tset=Tbef at the point in time of processing the need V(UID, DS, Stime) is changed depending on the change category DS of the need V(UID, DS, Stime), as illustrated in FIG. 7 (A) is used as the control plan corresponding to a persistent need. The change in the control setting value Tset through this control plan can be expressed by the following expression:

Tset=Tbef+Tdp(DS) (1)

The temperature setting value is an example of a control setting value Tset. The Tdp(DS) in Expression (1) is the magnitude of the change in the setting value. This setting value change magnitude Tdp(DS) is determined by the following equation:

Tdp(DS)=S(DS)×γdp(DS) (2)

As described above, when the informant reports “Hot,” the change category DS will be set to 1, and when the informant reports “Cold,” the change category DS will be set to −1. The S(DS) in Expression (2) is a coefficient indicating the direction of the change (increase vs. decrease) in the control setting value Tset corresponding to the change category DS. When the change category DS=1, the coefficient S(1)=−1, and when the change category DS=−1, the coefficient S(−1)=1. In other words, when the informant reports “Hot,” the coefficient S(DS) is set to −1, and the control setting value Tset is lowered, and if the informant reports “Cold,” then the coefficient S(DS) is set to 1, and the control setting value Tset is increased.

The γdp(DS) in Expression (2) is the setting value change magnitude corresponding to the change category DS. This setting value change magnitude γdp(DS) is determined in advance by the control contractor, the facilities manager, or the like, depending on the change category DS. Here the setting value change magnitude γdp(DS) is defined uniformly as 0.5° C. regardless of the value of the change category DS, but, of course, it may instead be given values that vary depending on the value of the change category DS.

On the other hand, a control plan wherein, for example, the control setting value Tset is changed in the same way as for the control plan corresponding to a persistent need but then, after the change in the setting value has been sustained for a sustaining time tα, the control setting value Tset is returned to Tset=Tbef from before responding to the reported need, may be set up as a control plan corresponding to a temporary need (a control plan corresponding to Ftmp=1) (FIG. 7 (B)). The changes in the control setting value Tset are as have been explained using Expression (1) and Expression (2). The sustaining time tα is the time for a sudden change in the metabolic rate of the occupant to approach stability, and may be set to, for example, 20 minutes, or the like. This sustaining time tα may be adjusted by the facilities manager, or the like, depending on operating conditions.

Finally, the equipment controlling portion 2 controls the air-conditioning equipment 7 corresponding to the informant identified by the informant identifying information UID based on the new control plan that has been determined by the control plan determining portion 3 (Step S1-4 in FIG. 5). That is, the equipment controlling portion 2 sets the new control setting value Tset to be applied to the air-conditioning equipment 7 based on the current control setting value Tset=Tbef that is applied to the air-conditioning equipment 7 at the point in time of processing the need V(UID, DS, Stime), the change category DS of the need V(UID, DS, Stime), and the control plan determined by the control plan determining portion 3. Moreover, the equipment controlling portion 2 controls of the air-conditioning equipment 7 so that the controlled quantity of the air conditioner (for example, the room temperature) will match the control setting value Tset (for example, a room temperature setting value). PID, for example, is well known as a control algorithm. Moreover, the equipment controlling portion 2 may determine air-conditioning equipment 7 corresponding to the informant based on information that associates occupants, occupied spaces of those occupants, and air-conditioning equipment 70 for air-conditioning zones corresponding to those occupied spaces.

The processes in Step S1-1 through S1-4 are repeated for the need each time the informant issues a new need report.

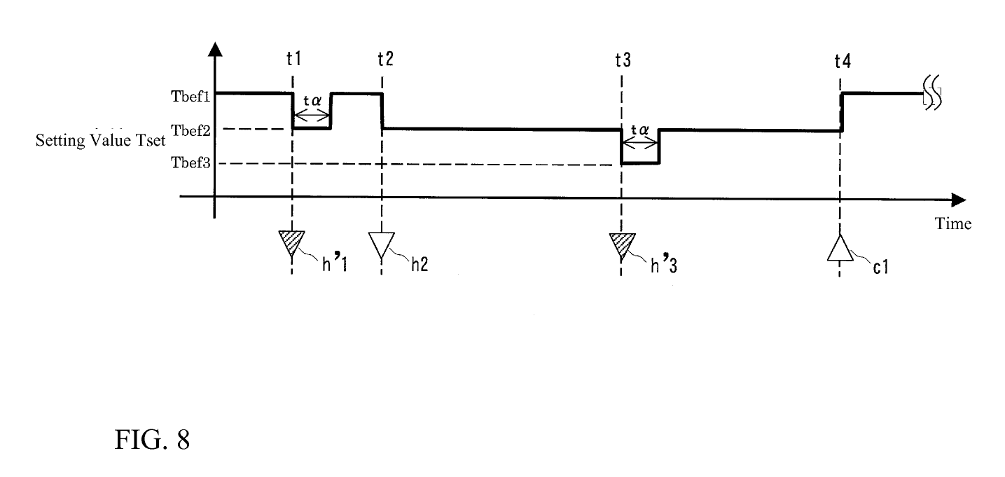

FIG. 8 illustrates one example of how the control setting value Tset is changed in response to a need report. In FIG. 8, h′1 and h′3 indicate “Hot” temporary needs, h2 indicates a “Hot” persistent need, and c1 indicates a “Cold” persistent need.

When, at a time t1, the “Hot” temporary need h′1 is produced, the control plan determining portion 3 determines a control plan for responding to a temporary need as the new control plan to be applied to the air-conditioning equipment 7. The equipment controlling portion 2, based on this control plan, reduces the control setting value Tset to Tbef2 in accordance with Expression (1) and Expression (2), and then, after the sustaining time tα (which is 30 minutes in the present example), restores the control setting value Tset to Tbef1 from before time t1.

Next, at a time t2, the “Hot” persistent need h2 is produced, the control plan determining portion 3 determines a control plan for responding to a persistent need as the new control plan to be applied to the air-conditioning equipment 7. The equipment controlling portion 2, based on this control plan, reduces the control setting value Tset to Tbef2 in accordance with Expression (1) and Expression (2).

Following this, at a time t3, the “Hot” temporary need h′3 is produced, and the control plan determining portion 3 determines a control plan for responding to a temporary need as the new control plan to be applied to the air-conditioning equipment 7. The equipment controlling portion 2, based on this control plan, reduces the control setting value Tset to Tbef3, and then, after the sustaining time tα, restores the control setting value Tset to Tbef2 from before time t3.

Next, at a time t4, the “Cold” persistent need c1 is produced, and the control plan determining portion 3 determines a control plan for responding to a persistent need as the new control plan to be applied to the air-conditioning equipment 7. The equipment controlling portion 2, based on this control plan, increases the control setting value Tset to Tbef1.

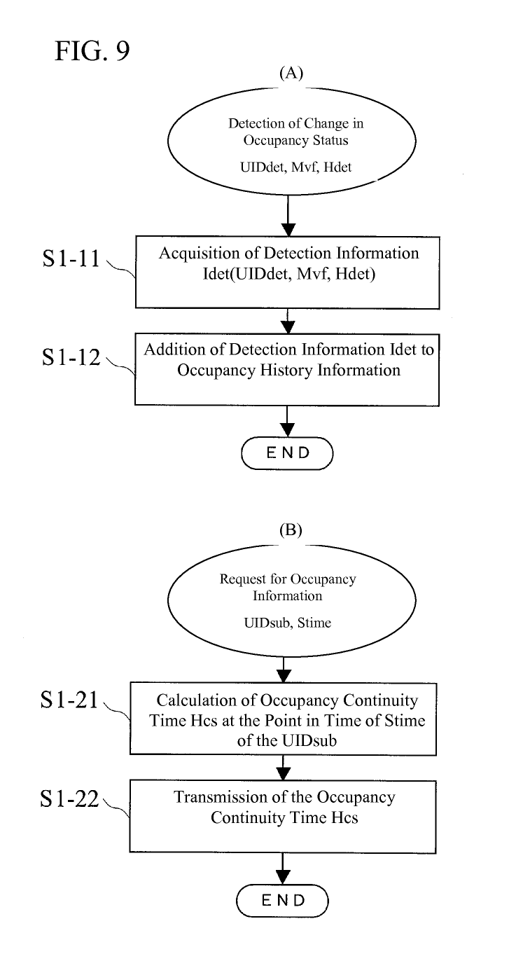

The operation of the occupancy status controlling portion 6 will be described next. FIG. 9 (A) and FIG. 9 (B) illustrate two types of operation flows executed by the occupancy status controlling portion 6. The occupancy status controlling portion 6 executes an updating operation for the occupancy history information indicated in FIG. 9 (A) when a change in the occupancy status of the occupant (present vs. absent) is detected by the presence/absence controlling system 9, and the occupancy information transmitting operation illustrated in FIG. 9 (B) is executed when occupancy information is requested by the need identifying portion 5.

When the presence/absence controlling system 9 detects a change in the occupancy status of the occupant, the occupancy status controlling portion 6 initiates the occupancy history information updating operation of FIG. 9 (A). The occupancy status controlling portion 6 obtains, from the presence/absence controlling system 9, the UIDdet that is the identifying information UID for identifying the occupant, movement information Mvf that indicates movement of the occupant into or out of the occupied space, and the detection time Hdet at which the entry or exit of the occupant was detected (Step S1-11 in FIG. 9 (A)).

Here the movement information Mvf is Mvf=1 when the occupant has entered the occupied space, and Mvf=0 when the occupant has exited the occupied space. That is, Mvf=1, if the presence/absence controlling system 9 is an entry/exit controlling system, indicates that the occupant has entered the occupied space, and if the presence/absence controlling system 9 is a presence/absence detecting system, indicates that the occupancy status for the occupant has changed from absent to present. Moreover, Mvf=0, if the presence/absence controlling system 9 is an entry/exit controlling system, indicates that the occupant has exited the occupied space, and if the presence/absence controlling system 9 is a presence/absence detecting system, indicates that the occupancy status for the occupant has changed from present to absent.

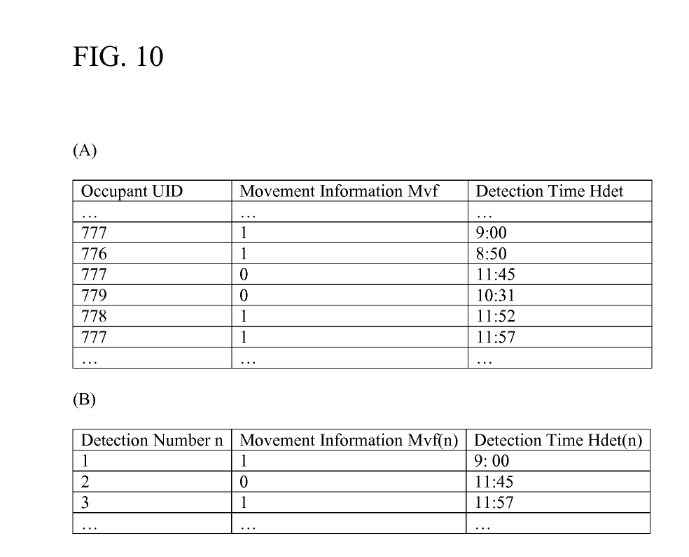

The occupancy status controlling portion 6 stores the detection information Idet(UIDdet, Mvf, Hdet), adding it to the occupancy history information that it controls (Step S1-12 in FIG. 9 (A)), thereby completing the occupancy history information updating operation. An example of occupancy history information is given in FIG. 10 (A). Note that in the present example the occupied space is an office wherein all occupants are anticipated to be absent at night, and the occupancy status controlling portion 6 performs a reset every day at 12:00 a.m. to erase the occupancy history information. However, if in consideration of late-night work, or the like, in the office, this reset is not performed, then this may be handled as appropriate by, for example, adding date information to the detection time to handle times that span different days.

Note that here the movement information Mvf may be transmitted from the presence/absence controlling system 9 to the occupancy status controlling portion 6, or the occupancy status controlling portion 6 may determine the movement information Mvf upon receipt, from the presence/absence controlling system 9, of information required for determining the movement information Mvf. In either case, the occupancy status controlling portion 6 acquires the detection information Idet(UIDdet, Mvf, Hdet) through information received from the presence/absence controlling system 9.

Following this, when occupancy information is requested by the need identifying portion 5, the occupancy status controlling portion 6 executes the occupancy information transmitting operation illustrated in FIG. 9 (B).

Upon receipt of a need V(UIDsub, DS, Stime) from a need inputting terminal 8, the identification processing portion 51 of the need identifying portion 5 transmits, to the occupancy status controlling portion 6, the UIDsub that is the identifying information UID for the informant, and the report time Stime, to request occupancy information for the informant identified by the identifying information UIDsub.

The occupancy status controlling portion 6, upon receipt of the request for the occupancy information, uses the occupancy history information that it maintains to calculate an occupancy continuity time Hcs for the informant identified by the identifying information UIDsub (Step S1-21 in FIG. 9 (B)). Here the occupancy continuity time Hcs is the cumulative value for the time over which the informant that has been identified by the identifying information UIDsub has been present continuously in the occupied space up until a calculation reference time. The occupancy status controlling portion 6 calculates the occupancy continuity time Hcs using the report time Stime as the calculation reference time.

The method for calculating the occupancy continuity time Hcs will be explained below. The occupancy status controlling portion 6 first extracts, from all of the occupancy history information, only the occupancy history information for the informant identified by the identifying information UIDsub. FIG. 10 (B) shows an example of extracting, from the occupancy history information in FIG. 10 (A), only the occupancy history information for the informant for which UIDsub=777. The detection number n in FIG. 10 (B) is a positive integer value that is added in the identification sequence for the occupancy history information, added for convenience in understanding the explanation.

Following this, the occupancy status controlling portion 6 extracts, from the extracted occupancy history information, the movement information Mvf and the detection time Hdet immediately prior to the report time Stime that is the calculation reference time. For example, in the example in FIG. 10 (B), when the report time Stime is 11:00 a.m., the movement information that is extracted is the movement information Mvf(1)=1 of the detection number n=1, and the detection time to be extracted is Hdet(1)=9:00. Similarly, if the report time Stime is 11:50 a.m., then the movement information to be extracted is the movement information Mvf(2)=0 of detection number n=2, and the detection time to be extracted is Hdet(2)=11:45.

If the detection number for the detection time immediately prior to the report time Stime is defined as m, then when Mvf(m)=1, the occupancy status controlling portion 6 calculates the occupancy continuity time Hcs as given in Expression (3).

Hcs=Stime−Hdet(m) (3)

Moreover, if Mvf(m)=0, then the occupancy status controlling portion 6 sets the occupancy continuity time Hcs to 0, as shown in Expression (4):

Hcs=0 (4)

That is, if the movement information Mvf(m) immediately prior to the report time Stime is 1, that is, if the informant identified by the identifying information UIDsub entered into the occupied space, then the occupancy status controlling portion 6 sets the occupancy continuity time Hcs to the time that elapsed from the detection time Hdet(m) immediately prior to the report time Stime up until the report time Stime, but if the movement information Mvf(m) is 0, that is, if the informant identified by the identifying information UIDsub has left the occupied space, then it sets the occupancy continuity time Hcs to Hcs=0.

Given this, the occupancy status controlling portion 6 sends, to the need identifying portion 5, the occupancy continuity time Hcs calculated through Expression (3) or Expression (4) (Step S1-22 in FIG. 9 (B)), to complete the occupancy information transmitting operation.

Table 1 shows examples of occupancy continuity times Hcs for various occupants calculated through Expression (3) or Expression (4) using 11:26 a.m. as the calculation reference time.

TABLE 1

| | Movement | | | |
|---|---|---|---|---|
| | Information Mvf | Detection Time | | |
| | Immediately | Hdet Immediately | Calcu- | Occupancy |
| Occu- | Prior to the | Prior to the | lation | Continuity |
| pant | Calculation | Calculation | Reference | Time Hcs |
| UID | Reference Time | Reference Time | Time | (min) |
| . . . | . . . | . . . | . . . | . . . |
| 775 | 1 | 9:00 | 11:26 | 146 |
| 776 | 0 | 10:28 | 11:26 | 0 |
| 777 | 1 | 10:01 | 11:26 | 85 |
| 778 | 1 | 11:12 | 11:26 | 14 |
| 779 | 0 | 9:52 | 11:26 | 0 |
| . . . | . . . | . . . | . . . | . . . |

For those occupants for whom the movement information Mvf corresponding to the detection time Hdet immediately prior to the 11:26 a.m. cancellation reference time is 0 (those occupants who were absent from the occupied space at 11:26 a.m.), the occupancy continuity time Hcs is 0, and for those occupants for whom the movement information Mvf is 1 (those occupants who were present in the occupied space at 11:26 a.m.), the amount of time that elapsed from the immediately previous detection time Hdet until the calculation reference time becomes the occupancy continuity time Hcs.

As described above, in the present example, using the occupancy continuity time for the informant in identifying the persistence category of the need and applying, to the air-conditioning equipment 7 that corresponds to that informant, a control plan that is based on the result of identifying the persistence category enables a reduction in the likelihood of destabilization of control while reducing the number of reports by the occupant and reducing the burden on the occupant in reporting work.

Moreover, while there were two categories, “Hot” and “Cold,” for the change categories for the needs in the present example, instead there may be, for example, five different change categories: “Hot,” “Somewhat hot,” “Neither hot nor cold,” “Somewhat cold,” and “Cold.” In this case, for example, for “Hot,” DS=1, for “Somewhat hot,” DS=2, for “Neither hot nor cold,” DS=3, for “Somewhat cold,” DS=4, and for “Cold,” DS=5. The coefficients S(DS) corresponding to the change categories DS=1, 2, 3, 4, and 5 are set, respectively, to −1, −1, 0, 1, and 1. Moreover, the setting value change magnitudes γdp(DS) corresponding to these change categories DS=1, 2, 3, 4, and 5 are set, respectively, to 1.0° C., 0.5° C., 0° C., 0.3° C., and 0.6° C. In this way, the setting value change magnitude γdp(DS) may differ depending on the change category DS.

Moreover, while an example of control that responds to the individual needs at the times at which need reports are produced was presented in the present example, this can of course be applied also to performing periodic control at, for example, 15 minute intervals. In this case, the need identifying portion 5 would maintain the needs V(UID, DS, Stime) from the informants temporarily in a database, and perform, with each control period, general processes such as a last-highest priority process that uses, as the representative need, only the most recent need within the period, a high-frequency occurrence process that uses, as the representative need, only the need that has occurred most often from among the plurality of needs that have been produced during the 15-minute period, a need ratio process that infers the representative need based on the ratios of the numbers of needs, relative to all of the needs, that have been produced during the 15-minute period (referencing Japanese Unexamined Patent Application Publication 2006-214624), or the like, to determine a need that is representative of the applicable period (hereinafter termed the “representative need”), and determine the change category DS of that representative need, while defining, as the report time Stime of the representative need, the time, for example, at which the change category DS was determined. Given this, the need identifying portion 5 may perform the processes in Step S1-2 through S1-4 in FIG. 5 for the representative need.

### Another Example

Another Example according to the present invention will be explained next. In the present example, an occupancy equivalent time that takes into account brief absences of the informant is used to identify whether or not a need is a temporary need, and an air-conditioning control plan is determined based on the identification results.

In the Example above, the time over which the occupant was present continuously in the occupied space was summed to produce the occupancy continuity time Hcs, and if the occupant left the occupied space, the occupancy continuity time Hcs was defined as 0, and when the occupant returned to the occupied space (reentered the occupied space), the occupancy continuity time Hcs was added up again beginning at 0.

However, if the occupied space is narrow, for example, if it is an area surrounding one's desk or a partition in a wide floor, such as in an air-conditioning zone (a control unit for air-conditioning), then if the occupant of an office were to perform an action of leaving his or her desk for a short period of time, such as going to a shared printer outside of the occupied space to pick up a document printed using a computer, or going to get a file or a book from a bookshelf that is outside of the occupied space, a change in occupancy status would be detected. However, typically there would be few cases wherein such an action of a short-term departure from one's desk would cause a major increase in the metabolic rate of the occupant. Given this, in the present example the persistence category for the need is identified using an occupancy equivalent time Heqs that is increased, within a specific range, depending on the occupancy continuity time when the occupant is present within the occupied space, and that is decreased, depending on the non-occupancy continuity time when the occupant is absent.

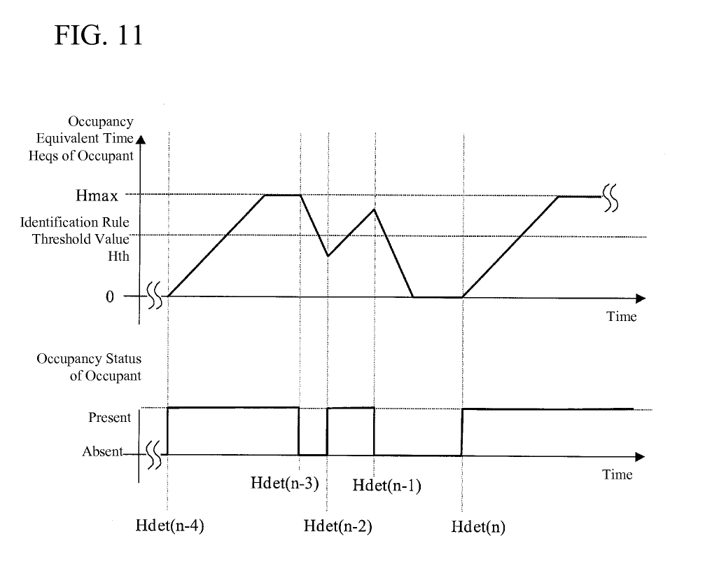

FIG. 11 is a diagram illustrating the relationship between the occupancy status of an occupant and the occupancy equivalent time Heqs. The Hdet(n−4), Hdet(n−2), and Hdet(n) in FIG. 11 are detection times at which entries of the occupant into the occupied space were detected by the presence/absence controlling system 9, and Hdet(n−3) and Hdet(n−1) are detection times at which exits of the occupant from the occupied space were detected by the presence/absence controlling system 9, where n is a positive integer value indicating the detection sequence.

As illustrated in FIG. 11, the occupancy equivalent time Heqs has an upper limit of Hmax and a lower limit of 0, and increases depending on the amount of time elapsed from the point in time of entry into the occupied space if the occupant is present, and decreases depending on the amount of time elapsed from the point of time of exit if the occupant is absent. Consequently, if, for example, an occupant that has been present for an occupancy equivalent time that adequately exceeds the aforementioned threshold value Hth then exits but returns to the occupied space after a short time, the occupancy equivalent time at the point in time of the return will be large when compared to what it would be after the occupant has had an extended absence. Consequently, a need reported after the occupant has returned to the occupied space will have a greater tendency to be identified as a persistent need the shorter the absence, and will have a greater tendency to be identified as a temporary need the longer the absence. That is, because there will be a tendency for a need that is reported by the occupant to be identified as a persistent need after departing for a short time, for which the increase in the metabolic rate of the occupant can be assumed to be small, this enables an increase in the accuracy of the need category identification that takes the metabolic rate of the occupant into account.

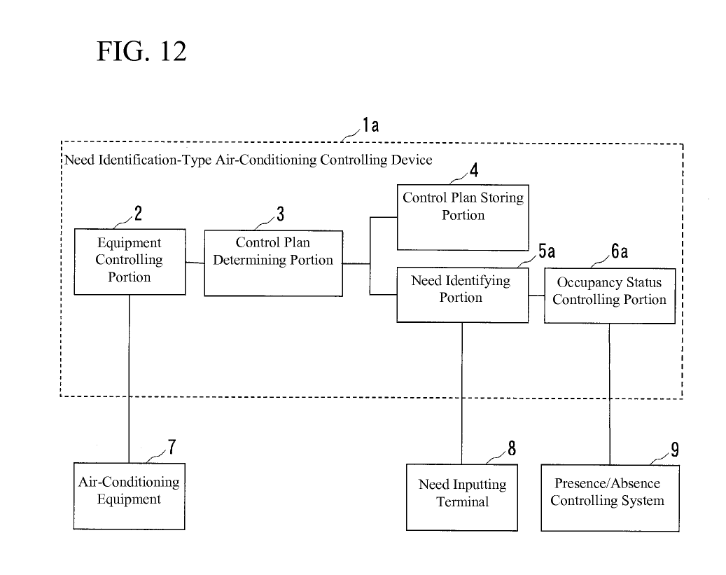

FIG. 12 is a block diagram illustrating the structure of a need identification-type air-conditioning controlling device according to the present example, where structures identical to those in FIG. 3 are assigned identical codes. The need identification-type air-conditioning controlling device 1a in the present example is provided with an equipment controlling portion 2, a control plan determining portion 3, a control plan storing portion 4, a need identifying portion 5a, and an occupancy status controlling portion 6a.

Because, in the present example, the occupancy equivalent time Heqs is used instead of the occupancy continuity time Hcs that was explained in the Example, a need identifying portion 5a is provided instead of the need identifying portion 5, and an occupancy status controlling portion 6a is provided instead of the occupancy status controlling portion 6. The structure of the need identifying portion 5a is identical to that of the need identifying portion 5 in the Example with the exception of the point that an occupancy equivalent time Heqs is used instead of the occupancy continuity time Hcs, and thus the codes of FIG. 4 will be used to explain the operation of the need identifying portion 5a.

Because the process flow in the need identification-type air-conditioning controlling device 1a is identical to that in the Example, FIG. 5 will be used to explain the operation of the need identification-type air-conditioning controlling device 1a. The process in Step S1-1 in FIG. 5 is identical to that in the Example.

When a need V(UID, DS, Stime) is received from a need inputting terminal 8, the identification processing portion 51 of the need identifying portion 5a queries the occupancy status controlling portion 6a regarding the occupancy equivalent time Heqs, which is occupancy information for the informant that is identified by the identifying information UID, to identify the persistence category of the need V(UID, DS, Stime) based on the occupancy equivalent time Heqs obtained from the occupancy status controlling portion 6a and on a temporary need identification rule that is set in advance in the identification rule storing portion 52 (Step S1-2 in FIG. 5). The operation of the occupancy status controlling portion 6a will be described below.

The identification processing portion 51 of the need identifying portion 5a compares the occupancy equivalent time Heqs at the point in time of the report time Stime by the informant, identified in the identifying information UID, to the threshold value Hth that has been set in advance, to determine an identification flag Ftmp that indicates the persistence category of the need V(UID, DS, Stime). Specifically, the identification processing portion 51 sets the identification flag Ftmp to Ftmp=1 when Heqs<Hth, that is, when the occupancy equivalent time Heqs is less than the threshold value Hth, and sets the identification flag Ftmp to Ftmp=0 if Heqs≧Hth, that is, if the occupancy equivalent time Heqs is equal to or greater than the threshold value Hth.

As described above, an identification flag Ftmp=1 indicates that the need V(UID, DS, Stime) is a temporary need, and the identification flag Ftmp=0 indicates that the need V(UID, DS, Stime) is a persistent need. The identification processing portion 51 associates a need change category DS and an identification flag Ftmp with the need V(UID, DS, Stime) that has been received from the need inputting terminal 8, and stores these as a need status DC(DS, Ftmp).

The processes in Steps S1-3 and S1-4 in FIG. 5 are identical to those explained in the Example, so explanations thereof are omitted.

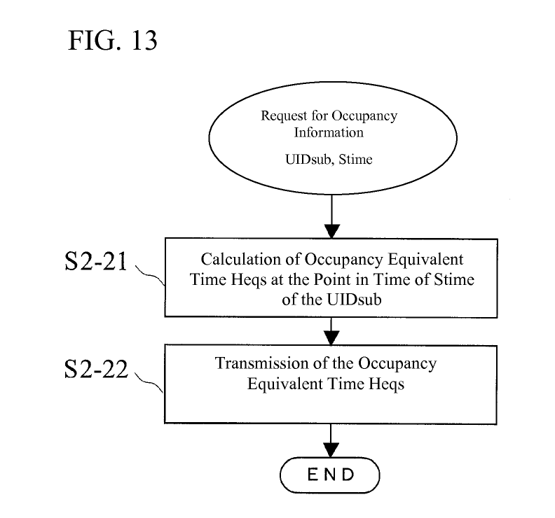

The operation of the occupancy status controlling portion 6a will be described next. The operation of the occupancy status controlling portion 6a when the presence/absence controlling system 9 detects a change in the occupancy status of the occupant is the same as that of the occupancy status controlling portion 6 in the Example, and is as explained in FIG. 9 (A), so the explanation thereof will be omitted here. FIG. 13 is a flowchart for explaining the operation of the occupancy status controlling portion 6a when there is a request for occupancy information from the need identifying portion 5a.

Upon receipt of a need V(UIDsub, DS, Stime) from a need inputting terminal 8, the identification processing portion 51 of the need identifying portion 5a transmits, to the occupancy status controlling portion 6a, the UIDsub that is the identifying information UID for the informant, and the report time Stime, to request occupancy information for the informant identified by the identifying information UIDsub.

The occupancy status controlling portion 6a, upon receipt of the request for the occupancy information, uses the occupancy history information that it maintains to calculate an occupancy equivalent time Heqs for the informant identified by the identifying information UIDsub (Step S2-21 in FIG. 13).

Given this, the occupancy status controlling portion 6a sends the calculated occupancy equivalent time Heqs to the need identifying portion 5a (Step S2-22 in FIG. 13), to complete the occupancy status transmitting operation.

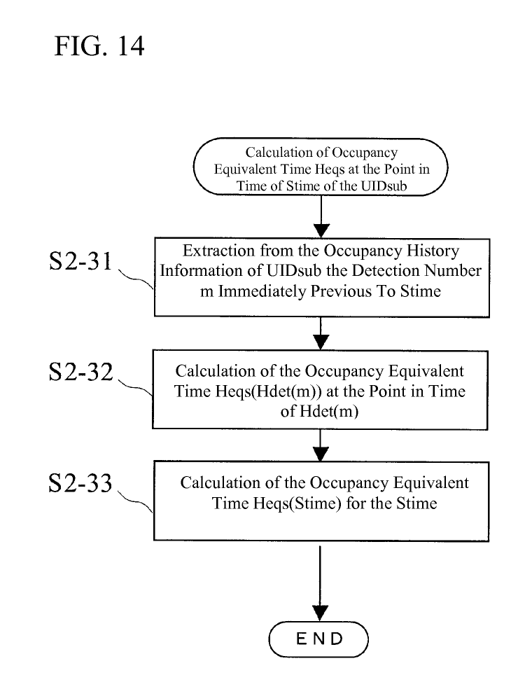

FIG. 14 is a flowchart for explaining a method for calculating the occupancy equivalent time Heqs. Note that in the present example as well, as with the Example, the occupancy information is resetted each day at 12:00 a.m.

The occupancy status controlling portion 6a extracts, from all of the occupancy history information, the occupancy history information for the informant identified by the identifying information UIDsub, and extracts, from that extracted occupancy history information, the detection number m of the detection time Hdet immediately prior to the report time Stime (Step S2-31 in FIG. 14), and then uses the occupancy history information extracted in Step S2-31 to calculate the occupancy equivalent time Heqs(Hdet(m)) for the point in time of the detection time Hdet(m) (Step S2-32 in FIG. 14).

The calculation formula for Heqs(Hdet(n)) for the occupancy equivalent time for an arbitrary detection number n (≧2) is given in Expression (5). Note that in the present example wherein the occupancy information is resetted at 12:00 a.m., anticipating that the occupant will be absent at that time, at n=1, that is, at the first time after the reset that the presence/absence controlling system 9 detects a change in the occupancy status for the occupant, the entry of the occupant into the occupied space (Mvf(1)=1) is detected, and so the initial value of the occupancy equivalent time is Heqs(Hdet(1))=0. If a different resetting method is used, then Heqs(Hdet(1)) should be set in advance as appropriate in consideration of the occupancy status of the occupant at the time of resetting.

Heqs(Hdet(n))=CUT{0,Hmax,(Heqs(Hdet(n−1))+P{Hdet(−1),Hdet(n),Mvf(n−1)})} (5)

Here, when the occupant is present at the point in time of the detection time Hdet(m), that is, when Mvf(m)=1, the function P, for an arbitrary time H′ with an arbitrary detection number n and wherein Hdet(n)≦H′≦Hdet(n+1) (Hdet(n)≦H′ if the n+1th detection has not yet been made) is satisfied will be the as given in Expression (6).

P{Hdet(n),H′,Mvf(n)}=H′−Hdet(n) (6)

Moreover, if, at the point in time of the detection time Hdet(n) the occupant is absent, that is, if Mvf(n)=0, then the function P will be as given in Expression (7).

P{Hdet(n),H′,Mvf(n)}=−β×(H′−Hdet(n)) (7)

β is a specific non-occupancy reduction factor (β>0). That is, the function P, when the occupant is present, is the time elapsed from the detection time Hdet(n) until H′, and when the occupant is absent, is a time wherein the time elapsed from the detection time Hdet(n) to H′ has been multiplied by (−β). Because the time H′ is the time wherein the occupancy equivalent time Heqs(Hdet(n)) is calculated, the function P increases with the passage of time H′ if the occupant is present and decreases with the passage of time H′ if the occupant is absent.

The function CUT {0,Hmax,X} is 0 if X<0, that is, is 0 if an arbitrary time X is less than 0.

CUT{0,Hmax,X}=0 (8)

Moreover, the function CUT {0,Hmax,X} is X if 0≦X≦Hmax, that is, is X if the time X is equal to or greater than 0 and no more than a specific occupancy equivalent time maximum value Hmax.

CUT{0,Hmax,X}=X (9)

Moreover, the function CUT {0,Hmax X} is Hmax if Hmax<X, that is, if the time X is greater than the occupancy equivalent time maximum value Hmax.

CUT{0,Hmax,X}=Hmax (10)

As is obvious from Expression (5), the time X is a time wherein the function P is added to the occupancy equivalent time Heqs(Hdet(n−1)) at the point in time of the immediately previous detection time Hdet(n−1).

The occupancy equivalent time maximum value Hmax and the non-occupancy reduction factor β, like the identification rule threshold value Hth, are values that are set by the control provider or the facilities manager. The occupancy equivalent time maximum value Hmax and the non-occupancy reduction factor β may be set as appropriate using as a guideline the amount of time over which an absence would continue, after the occupant has left the occupied space, before the occupancy equivalent time should be set to 0, that is, the amount of non-occupancy continuity time for which it can be assumed that an activity would be performed that would increase the metabolic rate.

When setting the occupancy equivalent time maximum value Hmax and the non-occupancy reduction factor β, the size of the occupied space, such as whether the occupied space is an extremely small area around one's desk or whether it is a larger areas such as a floor of a building or a building itself, and the activities that can be envisioned when the occupant is absent from the occupied space, should be taken into account. For example, if the entire area of the building is defined as the occupied space, this means that the occupant has left the building if he or she is absent, so it can be anticipated that even if the occupant has left for even a short time of just a few minutes, he or she will be walking outdoors, which would increase the metabolic rate. Moreover, if, for example, the occupied space is an extremely small area around the desk, then it is possible that an activity wherein there is an absence of about five or 10 minutes might be an activity wherein the occupant has walked in the vicinity of the occupied space, that is, it is possible that it is an activity that has little increase in the metabolic rate.

When calculating the occupancy equivalent time Heqs(Hdet(n)) in Expression 5, the occupancy equivalent time Heqs(Hdet(n−1)) from the point in time of the detection time Hdet(n−1) is required, and thus when, for example, calculating the occupancy equivalent time Heqs(Hdet(3)) when the detection number n=3, extracted in Step S2-31, the occupancy equivalent times Heqs(Hdet(1)) and Heqs(Hdet(2)), given in Expression (11) and Expression (12), are required.

Heqs(Hdet(1))=0 (11)

Heqs(Hdet(2))=CUT{0,Hmax,(Heqs(Hdet(1))+P{Hdet(1),Hdets(2),Mvf(1)})} (12)

Heqs(Hdet(3))=CUT{0,Hmax,(Heqs(Hdet(2))+P{Hdet(2),Hdet(3),Mvf(2)})} (13)

That is, it is necessary to sequentially calculate the occupancy equivalent times at detection numbers n=1, 2, . . . , m in order to calculate the occupancy equivalent time Heqs(Hdet(m)).

Following this, the occupancy status controlling portion 6a uses the occupancy equivalent time Heqs(Hdet(m)), calculated in Step S2-32, to calculate the occupancy equivalent time Heqs(Stime) at the report time Stime for the informant identified by the identifying information UIDsub (Step S2-33 in FIG. 14). This occupancy equivalent time Heqs(Stime) is calculated through Expression (14), which uses Stime instead of Hdet(n) in Expression (5), and uses m instead of (n−1). The function P and the function CUT are as explained above.

Heqs(Stime)=CUT{0,Hmax,(Heqs(Hdet(m))+P{Hdet(m),Stime,Mvf(m)})} (14)

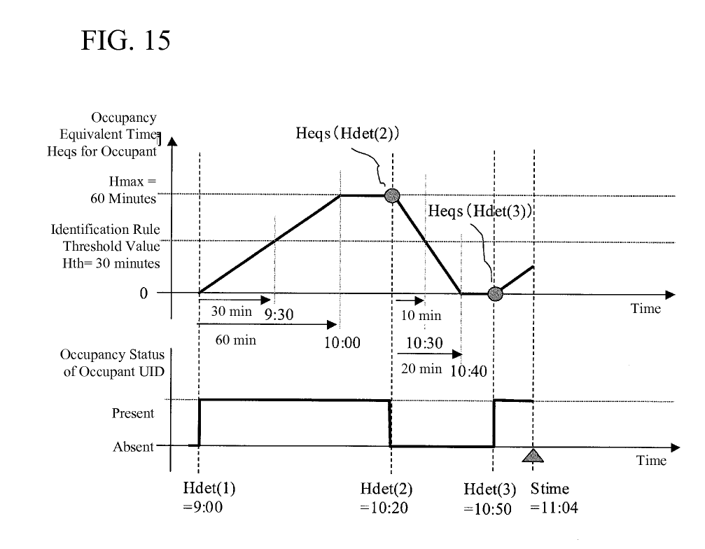

FIG. 15 shows an example of calculating the occupancy equivalent time Heqs for an occupant for which UIDsub=999. Here the threshold value Hth is 30 minutes, the occupancy equivalent time maximum value Hmax is 60 minutes, and the non-occupancy reduction factor β is 3. The occupant reports a need at a report time of Stime=11:04. The method for calculating the occupancy equivalent time Heqs(Hdet(m)) following the flow in FIG. 14 will be explained in the example in FIG. 15.

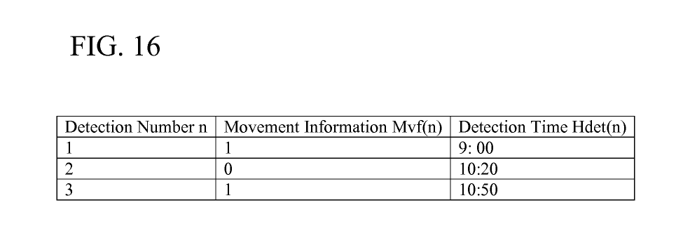

The occupancy status controlling portion 6a extracts the detection number m=3 immediately prior to the report time Stime (which, in this case, is 11:04 a.m.) through sorting the occupancy history information for the informant identified by UID sub=999 in ascending order by time, as shown in FIG. 16 (Step S2-31 in FIG. 14). Given this, the occupancy status controlling portion 6a calculates the occupancy equivalent time Heqs(Hdet(3)) at the point in time of the detection time Hdet(3) as follows (Step S2-32 in FIG. 14).

First the occupancy status controlling portion 6a calculates the occupancy equivalent time Heqs(Hdet(2)) using the occupancy equivalent time Heqs(Hdet(1)).

Heqs(Hdet(2))=CUT{0,60,(Heqs(Hdet(1))+P{Hdet(1),Hdet(2),Mvf(1)})} (15)

Because the initial value for the occupancy equivalent time Heqs(Hdet(1))=0, the detection time Hdet(1)=9:00, the movement information Mvf(1)=1, and the detection time Hdet(2)=10:20, the occupancy equivalent time Heqs(Hdet(2)) will be as per the following equation:

Heqs(Hdet(2))=CUT{0,60,(0+P{9:00,10:20,1})} (16)

From Expression (6), the function P {9:00,10:20,1} will be an elapsed time of 80 minutes from 9:00 a.m. until 10:20 a.m., and, additionally, from Expression (8) through Expression (10), the occupancy equivalent time Heqs(Hdet(2)) will be given by the following expression:

Heqs(Hdet(2))=Heqs(10:20)=CUT{0,60,80}=60(minutes) (17)

Similarly, the occupancy status controlling portion 6a calculates the occupancy equivalent time Heqs(Hdet(3)) using the occupancy equivalent time Heqs(Hdet(2)).

Heqs(Hdet(3))=CUT{0,60,(Heqs(Hdet(2))+P{Hdet(2),Hdet(3),Mvf(2)})} (18)

Because the occupancy equivalent time Heqs(Hdet(2))=60, the detection time Hdet(2)=10:20, the movement information Mvf(2)=0, and the detection time Hdet(3)=10:50, the occupancy equivalent time Heqs(Hdet(3)) will be as per the following equation:

Heqs(Hdet(3))=CUT{0,60,(60+P{10:20,10:50.0})} (19)

From Expression (7) the Function P {10:20,10:50,0} is the time elapsed from 10:20 a.m. until 10:50 a.m. (30 minutes) multiplied by (−β), and thus is −90 minutes, where the occupancy equivalent time Heqs(Hdet(3)), from Expression (8) through Expression (10) is as follows:

Heqs(Hdet(3))=Heqs(10:50)=CUT{0,60,(60-90)}=CUT{0,60,−30}=0(minutes) (20)

In this example, if an occupant for whom the occupancy equivalent time has reached the maximum value of 60 minutes exits the occupied space and is absent for 10 minutes, then the occupancy equivalent time goes to 30 minutes, which is equal to the identification rule threshold value Hth, and when another 10 minutes elapses, the occupancy equivalent time goes to zero. Given this, it can be seen that the longer the continuous time of absence, the greater the tendency of a need report, after again entering into the occupied space, to be identified as a temporary need, and the shorter the absence, which can be assumed to not greatly increase the metabolic rate of the informant, the more the tendency for a need report after reentry to be identified as a persistent need.

Following this, the occupancy status controlling portion 6a uses the occupancy equivalent time Heqs(Hdet(3)), calculated using Expression (20), to calculate the occupancy equivalent time Heqs(Stime)=Heqs(11:04)) at the point in time of the report time Stime by the informant, using Expression (14) and Expression (6) through Expression (10) (Step S2-33 in FIG. 14).

Heqs(11:04)=CUT{0,60,(Heqs(Hdet(3))+P{Hdet(3),11:04,Mvf(3)})}=CUT{0,60,(0+P{10:50,11:04,1})}=CUT{0,60,(0+14)}=14 (minutes) (21)

The occupancy equivalent time Heqs(11:04) is thus calculated as 14 minutes.

### Yet Another Example

Yet Another Example according to the present invention will be explained next. The present example provides a method for reducing the load of the occupancy equivalent time calculation in the Another Example. In the present example, the structure and the processing flow in the need identification-type air-conditioning controlling device is identical to that in the Another Example, where only the operation of the occupancy status controlling portion 6a is different, and thus the codes from FIG. 12 will be used.

In the present example, a calculated value for the occupancy equivalent time is stored each time an occupancy equivalent time is added to the occupancy history information that is controlled by the occupancy status controlling portion 6a to update the occupancy history information. Doing so makes it possible to avoid repetitively calculating the occupancy equivalent times at the time of occupancy information transmission, thus making it possible to accelerate processing through reducing the calculation overhead.

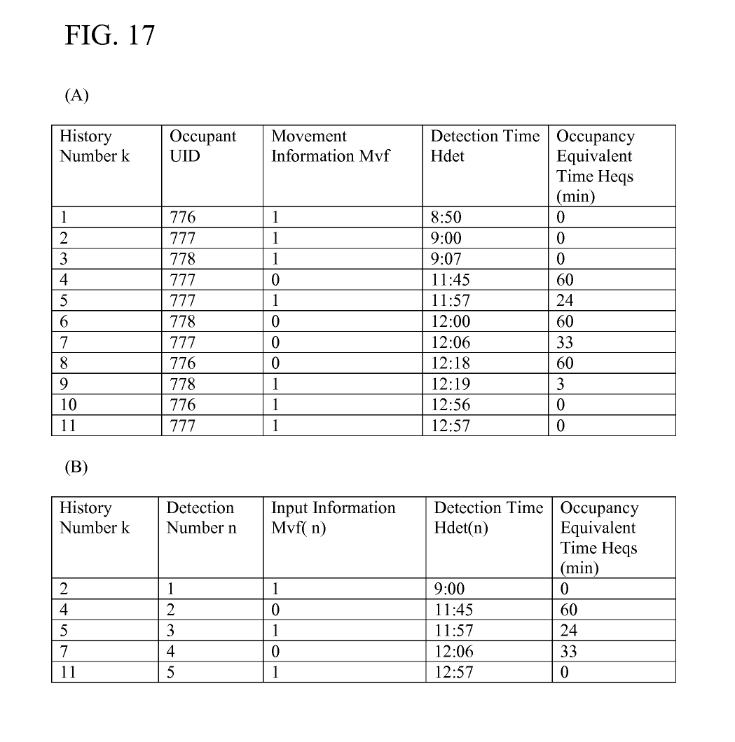

An example of the occupancy history information in the present example is given in FIG. 17 (A). This is an example wherein the occupancy equivalent time Heqs in FIG. 17 (A) is calculated using an occupancy equivalent time maximum value Hmax=60 minutes and a non-occupancy reduction factor β=3, the same as in FIG. 17, described above.

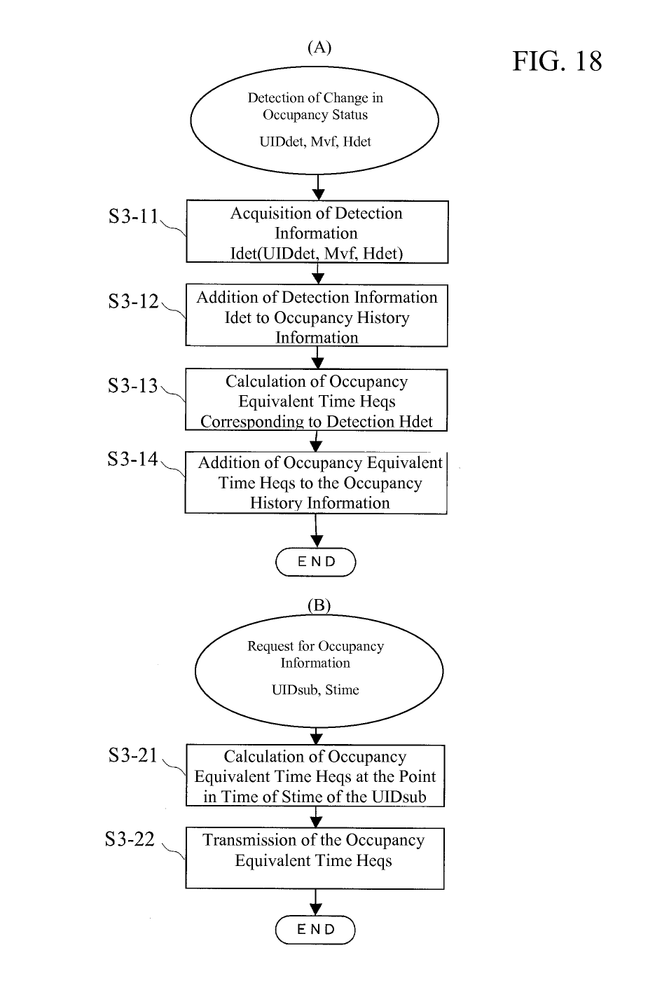

The operation of the occupancy status controlling portion 6a in the present example will be described next. FIG. 18 (A) and FIG. 18 (B) illustrate two types of operation flows executed by the occupancy status controlling portion 6a. The occupancy status controlling portion 6a executes an updating operation for the occupancy history information when a change in the occupancy status of the occupant is detected by the presence/absence controlling system 9, and the occupancy information transmitting operation illustrated in FIG. 18 (B) is executed when occupancy information is requested by the need identifying portion 5a.

When the presence/absence controlling system 9 detects a change in the occupancy status of the occupant, the occupancy status controlling portion 6a obtains, from the presence/absence controlling system 9, the identifying information UIDdet that identifies the occupant, the movement information Mvf that indicates whether the occupant entered or exited the occupied space, and the detection time Hdet at which the entry or exit of the occupant was detected (Step S3-11 in FIG. 18 (A)). Here UIDdet=777.

The process in Step S3-12 in FIG. 18 (A) is identical to that of Step S1-12 in FIG. 9 (A), so the explanation thereof will be omitted.

Following this, the occupancy status controlling portion 6a extracts, from all of the occupancy history information, the occupancy history information for the occupant identified by the identifying information UIDdet=777, as illustrated in FIG. 17 (B), and then calculates the occupancy equivalent time Heqs(Hdet(q)) for the point in time of the detection time Hdet(q) in this cycle, using the occupancy equivalent time Heqs(Hdet(q-1)) at the point in time of the detection time Hdet(q-1) that was one cycle previous to the detection time Hdet(q) for this cycle, using Expression (5) (Step S3-13 in FIG. 18 (A)).

Because the occupancy equivalent time Heqs(Hdet(q-1)) for the point in time of the detection time Hdet(q-1) from the previous time is stored in the occupancy history information for the occupant, it is not necessary to calculate sequentially the occupancy equivalent times before detection numbers n=1, 2, . . . , q, as it was in the Another Example.

Given this, the occupancy status controlling portion 6a adds the calculated occupancy equivalent time Heqs(Hdet(q)) to the record for the occupancy history information corresponding to the detection time Hdet(q) for the occupant identified by the identifying information UIDdet=777 (Step S3-14 in FIG. 18 (A)), completing the occupancy information updating operation.

For example, the occupancy equivalent time Heqs=0, corresponding to the detection time Hdet=12:57 in FIG. 17 (A) and FIG. 17 (B), is information that is calculated and added for the occupant identified by identifying information UIDdet=777 at the point in time of the occupancy history information updating at detection time Hdet=12:57.

Following this, if there is a request for occupancy information from the need identifying portion 5a, the occupancy status controlling portion 6a executes the occupancy information transmitting operation shown in the FIG. 18 (B).

Upon receipt of a need V(UIDsub, DS, Stime) from a need inputting terminal 8, the identification processing portion 51 of the need identifying portion 5a transmits, to the occupancy status controlling portion 6a, the UIDsub that is the identifying information UID for the informant, and the report time Stime, to request occupancy information for the informant identified by the identifying information UIDsub.

Upon receipt of this request for this occupancy information, the occupancy status controlling portion 6a uses the occupancy history information it maintains to calculate the occupancy equivalent time Heqs for the occupant identified by the identifying information UIDsub (Step S3-21 in FIG. 18), and sends the calculated occupancy equivalent time Heqs to the need identifying portion 5a (Step S3-22 in FIG. 18).

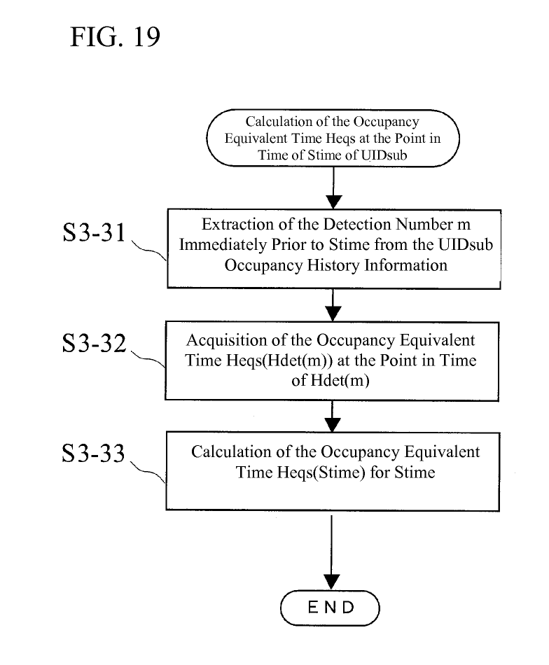

FIG. 19 is a flowchart for explaining a method for calculating the occupancy equivalent time Heqs. The occupancy status controlling portion 6a extracts, from all of the occupancy history information, the occupancy history information for the informant identified by the identifying information UIDsub, and extracts, from that extracted occupancy history information, the detection number m of the detection time Hdet immediately prior to the report time Stime (Step S3-31 in FIG. 19). Following this, the occupancy status controlling portion 6a obtains the occupancy equivalent time Heqs(Hdet(m)) at the point in time of the detection time Hdet(m) from the occupancy history information extracted in Step S3-31 (Step S3-32 in FIG. 19).

Following this, the occupancy status controlling portion 6a uses the occupancy equivalent time Heqs(Hdet(m)), calculated in Step S3-32, to calculate the occupancy equivalent time Heqs(Stime) at the report time Stime for the informant identified by the identifying information UIDsub (Step S3-33 in FIG. 19). The procedure in this Step S3-33 is identical to that of Step S2-33 in FIG. 14.

As described above, in the present example the occupancy equivalent time is added to the occupancy history information, making it possible to avoid the repeated calculations of occupancy equivalent times when sending the occupancy information, thus making it possible to increase speed by reducing the calculation overhead.

The need identification-type air-conditioning controlling devices 1 and 1a explained in the above examples, including the Example, Another Example and Yet Another Example, may be embodied through a computer that is provided with a CPU, a storage device, and an interface, and through a program for controlling these hardware resources. The CPU executes the processes explained in the above examples including the Example, Another Example and Yet Another Example, in accordance with a program that is stored in the memory device.

The present invention can be applied to technologies for reflecting, into air-conditioning control, needs pertaining to air-conditioning from informants.

Obviously, numerous modifications and variations of the present invention are possible in light of the above teachings. It is therefore to be understood that within the scope of the appended claims, the invention may be practiced otherwise than as specifically described herein.

1: A need identifying device, comprising:
an inputting unit that receives, from an informant, a need pertaining to air-conditioning; and
a need identifying unit that identifies whether the need from the informant is a temporary need or a persistent need, based on information pertaining to an activity that stabilizes the metabolic rate of the informant.

2: The need identifying device as set forth in claim 1, further comprising:
an occupancy status controlling unit that controls occupancy information of the informant as information pertaining to an activity that stabilizes the metabolic rate of the informant, wherein:
the need identifying unit includes
an identification rule storing unit that stores an identification rule in advance, and
an identification processing unit that identifies whether the need from the informant is a temporary need or a persistent need, based on occupancy information of the informant and on the identification rule.

3: The need identifying device as set forth in claim 2, wherein:
the occupancy status controlling unit calculates an occupancy continuity time of the informant in a specific space, as occupancy information of the informant;
the identification rule storing unit stores a rule, as the identification rule, for identifying a persistence category of a need by comparing the occupancy information of the informant to a predetermined identification threshold value; and
the identification processing unit identifies the need from the informant as a temporary need or a persistent need by comparing the occupancy continuity time to the identification threshold value following the identification rule.

4: The need identifying device as set forth in claim 2, wherein:
the occupancy status controlling unit calculates, as the occupancy information of the informant, an occupancy equivalent time wherein the occupancy continuity time of the informant in a specific space is corrected by a non-occupancy continuity time;
the identification rule storing unit stores a rule, as the identification rule, for identifying a persistence category of a need by comparing the occupancy information of the informant to a predetermined identification threshold value; and
the identification processing unit identifies the need from the informant as a temporary need or a persistent need by comparing the occupancy equivalent time to the identification threshold value following the identification rule.

5: An air-conditioning control system, comprising:
a need identifying device including
an inputting unit that receives, from an informant, a need pertaining to air-conditioning, and
a need identifying unit that identifies whether the need from the informant is a temporary need or a persistent need, based on information pertaining to an activity that stabilizes the metabolic rate of the informant;
a control plan storing unit that stores, in advance, respectively for temporary needs and for persistent needs, control plans wherein rules for changing control setting values for air-conditioning in accordance with a need from an informant are established;
a control plan determining unit that determines, from the control plans stored in the control plan storing unit, a control plan corresponding to the identification result of the need identifying device, as a control plan to be applied to the air-conditioning equipment; and
an equipment controlling unit that controls the air-conditioning equipment based on the control plan determined by the control plan determining unit.

6: The air-conditioning system as set forth in claim 5, wherein:
a control plan corresponding to a temporary need is a control plan that establishes that the control setting value will change in accordance with a need from an informant, and that the control setting value will be returned to the value from prior to the change after a specific sustaining time has elapsed; and
a control plan corresponding to a persistent need is a control plan that establishes that the control setting value will be changed on a persistent basis in accordance with a need from the informant.

7: A need identifying method, comprising:
an inputting step for receiving, from an informant, a need pertaining to air-conditioning; and
a need identifying step for identifying whether the need from the informant is a temporary need or a persistent need, based on information pertaining to an activity that stabilizes the metabolic rate of the informant.

8: The need identifying method as set forth in claim 7, further comprising:
an occupancy status detecting step for calculating occupancy information of the informant as information pertaining to an activity that stabilizes the metabolic rate of the informant, prior to the need identifying step, wherein:
the need identifying step includes a step for referencing an identification rule storing unit that stores an identification rule in advance, and for identifying whether the need from the informant is a temporary need or a persistent need, based on occupancy information of the informant and on the identification rule.

9: The need identifying method as set forth in claim 8, wherein:
the occupancy status detecting step calculates an occupancy continuity time of the informant in a specific space, as occupancy information of the informant;
the identification rule storing unit stores a rule, as the identification rule, for identifying a persistence category of a need by comparing the occupancy information of the informant to a predetermined identification threshold value; and
the identification processing step identifies the need from the informant as a temporary need or a persistent need by comparing the occupancy continuity time to the identification threshold value following the identification rule.

10: The need identifying method as set forth in claim 8, wherein:
the occupancy status detecting step calculates, as the occupancy information of the informant, an occupancy equivalent time wherein the occupancy continuity time of the informant in a specific space is corrected by a non-occupancy continuity time;
the identification rule storing unit stores a rule, as the identification rule, for identifying a persistence category of a need by comparing the occupancy information of the informant to a predetermined identification threshold value; and
the identification processing step identifies the need from the informant as a temporary need or a persistent need by comparing the occupancy equivalent time to the identification threshold value following the identification rule.

11: A air-conditioning controlling method, comprising:
an inputting step for receiving, from an informant, a need pertaining to air-conditioning;
a need identifying step for identifying whether the need from the informant is a temporary need or a persistent need, based on information pertaining to an activity that stabilizes the metabolic rate of the informant;
a control plan determining step for determining a control plan, from the control plans stored in a control plan storing unit, a control plan corresponding to the identification result of the need identifying step, as a control plan to be applied to the air-conditioning equipment by referencing the control plan storing unit that stores, in advance, respectively for temporary needs and for persistent needs, control plans wherein rules for changing control setting values for air-conditioning in accordance with a need from an informant are established; and
an equipment controlling step for controlling the air-conditioning equipment based on the control plan determined by the control plan determining step.

12: The air conditioning controlling method as set forth in claim 11, further comprising:
a control plan corresponding to a temporary need is a control plan that establishes that the control setting value will change in accordance with a need from an informant, and that the control setting value will be returned to the value from prior to the change after a specific sustaining time has elapsed; and
a control plan corresponding to a persistent need is a control plan that establishes that the control setting value will be changed on a persistent basis in accordance with a need from the informant.
